(19) United States
(12) Patent Application Publication
(10) Pub. No.: US 2009/0219431 A1
(43) Pub. Date: Sep. 3, 2009

(54) Image Capture Device

(75) Inventor: Kenji ISHIBASHI, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/391,649

(22) Filed: Feb. 24, 2009

(30) Foreign Application Priority Data
Feb. 25, 2008 (JP) 2008-043238

(51) Int. Cl. H04N 5/222

(52) U.S. Cl. 348/333.08; 348/E05.022

(57) ABSTRACT

An image capture device comprises a camera body held by a user for capturing an image, a display for displaying an image while captured, and a virtual image optical system for producing a virtual image of the image displayed on the display. The display is openably/closably supported by the camera body and positioned in opened/closed positions to expose or unexpose an image display surface. The optical system is contained in the camera body to produce a virtual image of the image on the display to allow the user to observe the virtual image through a viewing opening of the camera body. The user, even if presbyopic, can clearly observe an image, while captured, through the viewing opening. This device has reduced cost and improved design, and allows a user, even if presbyopic, to clearly observe an image while captured, and can prevent degradation in the quality of the observed image.

### BACKGROUND OF THE INVENTION

1. Field of the Invention

The present invention relates to an image capture device for capturing an image.

2. Description of the Related Art

An image capture device is known which can be held by a hand of a user to capture an image, and which allows the user to observe an image while captured. FIGS. 7 and 8 each show an example of such an image capture device. FIG. 7 shows an image capture device 70 comprising a camera body 71 to be held by a hand of a user for capturing an image of a target object, and a display 72 for displaying an image while captured by the camera body 71. The camera body 71 has built therein e.g. an optical system and a photoelectric conversion element (not shown) for image capture. The photoelectric conversion element converts an optical image captured by the optical system to image data of an electric signal so as to capture the image. Based on the image data obtained from the photoelectric conversion element, the display 72 displays the image while captured by the camera body 71.

The display 72 is mounted on a lid member 73 pivotally supported by the camera body 71. When the lid member 73 is pivoted, the display 72 is opened in an opened position with an image display surface 72a thereof being exposed, and closed in a closed position with the image display surface 72a unexposed. In other words, the display 72 is openably and closably supported by the camera body 71 via the lid member 73 in the opened position and closed position with the image display surface 72a exposed and unexposed, respectively. When capturing an image using the image capture device 70, the user can observe the image, while captured, by seeing the display 72 brought to the opened position.

FIG. 8 shows an image capture device 80 comprising, in addition to the structure of the image capture device 70 shown in FIG. 7, an EVF (electronic viewfinder) 81 for the user to observe an image, while captured by the camera body 71, by putting an eye to it. The EVF 81 comprises: a viewing opening 81a provided in the camera body 71; an optical system and an image display element (not shown) built in the camera body 71 for ocular observation. The EVF 81 is designed so that based on image data obtained from the photoelectric conversion element for image capture, an image while captured by the camera body 71 is displayed on the image display element for ocular observation, whereby through the viewing opening 81a and the optical system for ocular observation, the user can observe the image displayed on the image display element for ocular observation.

The image capture device 80 having such a configuration has a dual function for a user during image capture. First, by seeing the display 72, the user can observe an image while captured by the camera body 71. The user can also observe the image, while captured by the camera body 71, by looking into the viewing opening 81a of the EVF 81. When the user looks into the viewing opening 81a of the EVF 81, the user can readily hold the camera body 71 with the arms on the sides of its body and at the same time can observe the image while captured. This makes it possible for the user to prevent hand-shake during image capture.

However, each of the image capture devices 70 and 80 described above has drawbacks in that when a user observes an image, while captured, by seeing the display 72, the user may find it difficult to clearly observe an image while captured if, for example, the user is presbyopic (farsighted) because the observation distance from the eye of the user to the display 72 is too short. Thus, it can be considered that the optical system for ocular observation in the image capture device 80 uses a virtual image optical system which makes it possible to a presbyopic user to clearly observe an image. However, this increases the cost because it requires an image display element for ocular observation.

As another solution to a presbyopic user, an image capture device is known in which a set of enlarging lenses is provided so as to be able to enter and exit an area in front of a display as disclosed in e.g. Japanese Laid-open Patent Publication 2001-268403. The image capture device of this patent publication is designed so that while the enlarging lens set enters an area, or is present, in front of the display, the enlarging lens set produces an enlarged virtual image of an image displayed on the display. In other words, while the enlarging lens set is present in front of the display, a user can observe an enlarged image of the image on the display as a virtual image, namely can clearly observe an image, while captured, by seeing the display through the enlarging lens set even if the user is presbyopic.

In this image capture device, the enlarging lens set is placed outside, and pivotally supported by, a camera body such that by being pivoted, the enlarging lens set can enter and exit the area in front of the display. Normally, the enlarging lens set is designed to be smaller than the display, but relatively larger than the camera body. Thus, the image capture device does not have a good design because the enlarging lens set is placed outside the camera body, and also because the enlarging lens set is relatively large. In addition, the placement of the enlarging lens set outside the camera body may cause the user to contact the enlarging lens set by hand, thereby staining or damaging the enlarging lens set, which in turn may degrade the quality of the image observed through the enlarging lens set. These problems are to be solved.

There are also other known devices in the relevant art. For example, Japanese Laid-open Patent Publication 2002-116407 discloses a display device which can display an image displayed on a display in two ways by changing the distance between the display and a lens: enlarged virtual image display with a wide viewing angle based on the enlarging effect of the lens; and direct display not substantially based on the enlarging effect of the lens. Further, Japanese Laid-open Patent Publication Hei 9-121300 discloses an image capture device which, according to the position of a display pivotally mounted on a camera body, corrects an up-down reversal and a left-right reversal of an image displayed on the display.

Further, Japanese Laid-open Patent Publication 2005-244632 discloses an image capture device in which a still image capture unit for capturing a still image and a moving image capture unit for capturing a moving image are pivotally supported by a main body having a display. Further, Japanese Laid-open Patent Publication 2006-267202 discloses an information terminal device which displays information on an image display unit so as to allow the information to appear on the surface of the ground or floor as a virtual image, thereby giving a user an impression that the information is displayed on the ground or floor. In addition, Japanese Laid-open Patent Publication Hei 5-344392 discloses an electronic viewfinder which is designed to be usable as a projector such that an image displayed on a liquid crystal display panel is formed on a screen as a real image by moving a lens forward. However, none of these known devices in the relevant art can solve the problems described above.

### SUMMARY OF THE INVENTION

An object of the present invention is to provide an image capture device which, with reduced cost and improved design, allows a user to clearly observe an image while captured even if the user is presbyopic, and which can prevent degradation in the quality of the observed image.

This object is achieved according to the present invention by an image capture device comprising: a camera body to be held by a user for capturing an image of a target object; a display with an image display surface for displaying an image while captured by the camera body; and a virtual image optical system for producing a virtual image of the image displayed on the display. The display is openably and closably supported by the camera body so as to be positioned in an opened position to expose the image display surface and a closed position to unexpose the image display surface. The camera body has a viewing opening for a user to observe the image, while captured by the camera body, by putting an eye to the camera body. Further, the virtual image optical system is contained in the camera body and produces the virtual image of the image displayed on the display so as to allow the user to observe the virtual image through the viewing opening.

According to the image capture device of the present invention having the structure described above, a user can observe an image (while captured) displayed on the display as a real image by directly seeing the display. The user can also observe the image on the display through the viewing opening of the camera body as a virtual image produced by the virtual image optical system by putting an eye to the camera body and looking into the viewing opening. In other words, the user, if normally sighted, can clearly observe an image, while captured, by directly seeing the display. If the user is presbyopic, the user can also clearly observe an image, while captured, through the viewing opening of the camera body. The image capture device thus has improved convenience of use.

Furthermore, the image capture device is designed so that the virtual image optical system produces a virtual image of an image displayed on the display, so as to allow the user to observe the virtual image through the viewing opening. Thus, it is not necessary to separately provide e.g. an image display element in the camera body, thereby preventing an increase in cost. In addition, the virtual image optical system is designed to allow the user to observe the virtual image through the viewing opening (i.e. by putting an eye to the camera body), so that the virtual image optical system can be small in size, thereby reducing the size of the image capture device. Further, since the virtual image optical system is contained in the camera body, the image capture device can have an improved design. Besides, the provision of the virtual image optical system inside the camera body makes it possible to prevent the hand of the user from touching the virtual image optical system, thereby preventing the virtual image optical system from being stained or damaged, and also preventing degradation in the quality of the image observed through the viewing opening. In summary, the image capture device of the present invention has reduced cost and improved design, and allows a user to clearly observe an image while captured even if the user is presbyopic, and further can prevent degradation in the quality of the observed image.

Preferably, the display can be positioned in a first opened position as the opened position to expose the image display surface where the image display surface is exposed and substantially perpendicular to a direction for the camera body to capture an image. When the display is in the first opened position, the virtual image optical system and the viewing opening are positioned outside a rectangular space which is formed by indefinitely extending the image display surface in a direction perpendicular thereto. This is preferable because when the user directly sees the display with the display brought to the first opened position, the view of the user is not blocked by the virtual image optical system and the viewing opening, thereby allowing the user to easily observe an image while captured, and easily capture an image, improving convenience of use.

Further preferably, the virtual image optical system produces the virtual image so as to allow the user to observe the virtual image in a direction parallel to the direction for the camera body to capture the image. This is preferable because when the user observes an image, while captured, through the viewing opening of the camera body, the direction of the line of sight of the user (image observation direction by the user) is parallel to the image capture direction, so that the user can easily capture the image, thereby improving convenience of use.

Further, it can be designed so that the virtual image optical system produces the virtual image so as to allow the user to observe the virtual image through the viewing opening when the display is in the first opened position.

It can also be designed so that the display can be positioned in a second opened position as the opened position which is between the first opened position and the closed position of the display to unexpose the image display surface, and that when the display is in the second opened position, the virtual image optical system produces the virtual image so as to allow the user to observe the virtual image through the viewing opening.

Still further preferably, the image capture device further comprises notifying means for notifying that the image capture device is in a state in which the virtual image can be observed through the viewing opening. This is preferable because without actually seeing through the viewing opening, the user can recognize whether the image capture device is in a state in which the image while captured can be observed through the viewing opening, thereby improving convenience of use.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1A is a schematic perspective view of an image capture device according to a first embodiment of the present invention when a user directly sees a display which is in a first opened position, while FIG. 1B is a schematic perspective view of the image capture device when the user looks into a viewing opening;

FIG. 2 is a schematic top plan view, partially in cross section, of the image capture device when the display is in the first opened position;

FIG. 3 is a schematic view for explaining the principle of producing a virtual image of an image displayed on the display by using a virtual image optical system;

FIG. 4A is a schematic perspective view of an image capture device according to a second embodiment of the present invention when a user directly sees a display which is in a first opened position, while FIG. 4B is a schematic perspective view of the image capture device when the display is in a second opened position, and the user looks into a viewing opening;

FIG. 5 is a schematic top plan view, partially in cross section, of the image capture device when the display is in the second opened position;

FIG. 6A and FIG. 6B are each a schematic top plan view, partially in cross section, of a portion of the image capture device, showing a display position holding mechanism to hold the display in the first opened position and the second opened position, respectively;

FIG. 7 is a schematic perspective view of a conventional image capture device; and

FIG. 8 is a schematic perspective view of another conventional image capture device.

### DESCRIPTION OF THE PREFERRED EMBODIMENTS

Embodiments of the present invention, as best mode for carrying out the invention, will be described hereinafter with reference to the drawings.

The present invention relates to an image capture device. It is to be understood that the embodiments described herein are not intended as limiting, or encompassing the entire scope of, the present invention. Note that like parts are designated by like reference numerals, characters or symbols throughout the drawings.

### First Embodiment

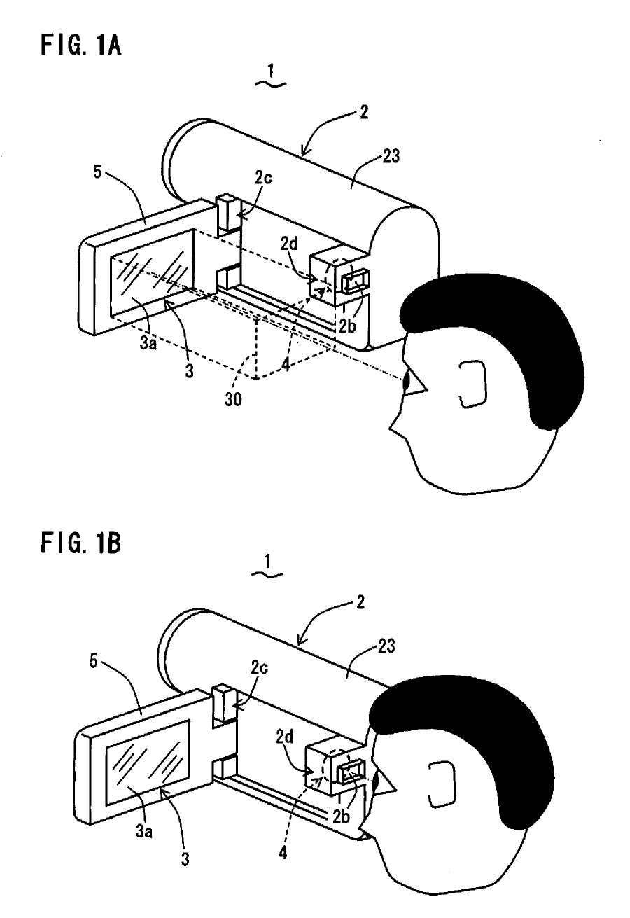

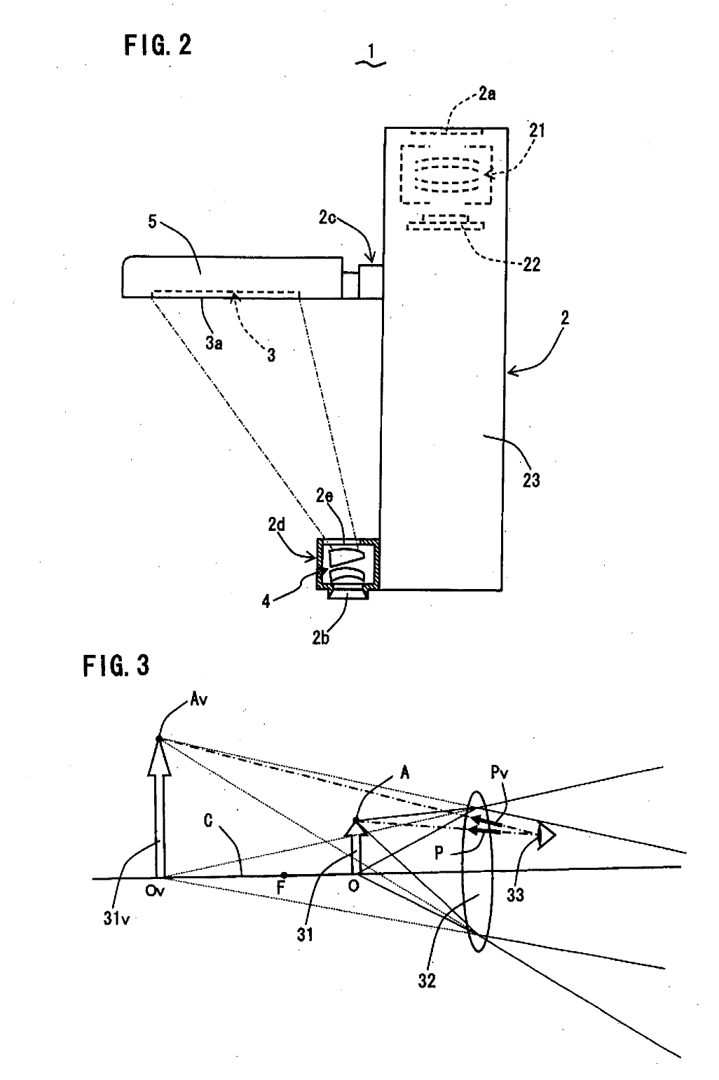

Referring to FIGS. 1A and 1B and FIG. 2, an image capture device 1 according to a first embodiment of the present invention will be described.

FIG. 1A is a schematic perspective view of an image capture device 1 according to the first embodiment when a user directly sees a display 3 which is in a first opened position, while FIG. 1B is a schematic perspective view of the image capture device 1 when the user looks into a viewing opening 2b. On the other hand, FIG. 2 is a schematic top plan view, partially in cross section, of the image capture device 1 when the display 3 is in the first opened position. The image capture device 1 optically captures a target object, and converts an optical image of the target object, thus captured, to image data of an electric signal so as to capture the image of the target object. The image capture device 1 is designed so that a user can hold it in hand for image capture, and can observe an image while captured.

The image capture device 1 comprises: a camera body 2 to be held by a hand of a user for capturing an image of a target object; a display 3 for displaying an image while captured by the camera body 2; a virtual image optical system 4 for producing a virtual image of the image displayed on the display 3; and so on. The camera body 2 has a housing 23 containing an image capture optical system 21, a photoelectric conversion element 22 and so on. The photoelectric conversion element 22 converts an optical image captured by the image capture optical system 21 to image data of an electric signal for image capture. The camera body 2 has a shape so that the user can hold it in one hand, and also has an image capture aperture 2a. Thus, the camera body 2 is designed so that while held by the hand of the user, it allows the image capture optical system 21 and the photoelectric conversion element 22 to capture an image through the image capture aperture 2a. The camera body 2 further comprises a viewing opening 2b for the user to observe an image, while captured by the camera body 2, by putting an eye to it. The camera body 2 has a function to store an image, while captured, as a still image or a moving image.

Based on the image data obtained from the photoelectric conversion element 22 contained in the camera body 2, the display 3 displays the image, while captured by the camera body 2, on an image display surface 3a under the control of a controller (not shown). The display 3 is mounted on a lid member 5 pivotally supported by the camera body 2. The lid member 5 is supported by the camera body 2 so as to pivot around the central axis of a shaft (not shown) in a pivotal support member 2c. When the lid member 5 is pivoted, the display 3 is opened in an opened position with the image display surface 3a thereof being exposed, and closed in a closed position with the image display surface 3a facing the side surface of the camera body 2 and being unexposed. In other words, the display 3 is openably and closably supported by the camera body 2 via the lid member 5 in the opened position and closed position with the image display surface 3a exposed and unexposed, respectively.

By bringing the display 3 to the opened position, the image display surface 3a is exposed so as to make it possible to observe an image displayed on the image display surface 3a of the display 3. Thus, the user can observe an image displayed on the display 3 (image while captured) as a real image by directly seeing the display 3 with the display 3 brought to the opened position. As an opened position of the display 3 to expose the image display surface 3a, the display 3 can be positioned in a position (first opened position which is a position shown in FIGS. 1A and 1B and FIG. 2) where the image display surface 3a is exposed and substantially perpendicular to the direction for the camera body 2 to capture an image (i.e. central direction in the light receiving field of view of the image capture optical system 21).

The virtual image optical system 4 produces a virtual image of an image displayed on the display 3 such that even a presbyopic (farsighted) user, for example, can clearly observe an image while captured, namely that the user can observe the image on the display 3 as a virtual image. The virtual image optical system 4 is built or contained in the camera body 2. More specifically, the virtual image optical system 4 is fixed in the housing 23 of the camera body 2. The camera body 2 has a virtual image optical system container 2d for accommodating the virtual image optical system 4. The virtual image optical system container 2d projects from the side surface of the camera body 2, and has provided in a front surface thereof a light receiving aperture 2e for the virtual optical system 4 to receive light from the display 3. The viewing opening 2b is provided in a rear surface of the virtual image optical system container 2d (which is also a rear surface of the camera body 2).

When the display 3 is in the first opened position (where the image display surface 3a is exposed and positioned to be substantially perpendicular to the direction for the camera body 2 to capture an image), the virtual image optical system 4, the viewing opening 2b and the virtual image optical system container 2d are positioned outside a rectangular space 30 which is formed by indefinitely extending the image display surface 3a in a direction perpendicular thereto such that the virtual image optical system 4, the viewing opening 2b and the virtual image optical system container 2d do not block the view of the user (namely these elements 4, 2b and 2d are positioned not to overlap the image display surface 3a of the display 3) when seeing the image display surface 3a in the first opened position. Thus, when the user observes an image, while captured, by directly seeing the display 3 in the first opened position, the view of the user is not blocked by the virtual image optical system 4, the viewing opening 2b and the virtual image optical system container 2d.

The virtual image optical system 4 produces a virtual image of an image displayed on the display 3 so as to make it possible to observe the virtual image on the display 3 through the viewing opening 2b when the display 3 is in the first opened position. In other words, by bringing the display 3 to the first opened position and looking into the viewing opening 2b of the camera body 2 by putting an eye thereto, the user can observe the image (while captured) on the display 3 as a virtual image produced by the virtual image optical system 4. In addition, after the display 3 is brought to the first opened position, the user can both observe the image, while captured, by directly seeing the display 3, and observe the image, while captured, by seeing through the viewing opening 2b, without being required to open or close the display 3.

Further, the virtual image optical system 4 produces a virtual image of an image displayed on the display 3 so as to allow the user to observe the virtual image in a direction parallel to the image capture direction by the camera body 2 (i.e. the direction for the camera body 2 to capture the image). More specifically, it produces the virtual image so that when the user looks into the viewing opening 2b with the line of sight parallel to the image capture direction, the user can observe the virtual image on the line of sight. Thus, when the user observes the image, while captured, through the viewing opening 2b of the camera body 2, the direction of the line of sight of the user (image observation direction by the user) is parallel to the image capture direction.

FIG. 3 is a schematic view for explaining the principle of producing a virtual image of an image displayed on the display 3 by using the virtual image optical system 4. Referring to FIG. 3, assume that an object 31 (target object) is observed through a lens 32 having light collecting function. If the object 31 is present in a position O which is closer to the observer (user) than the focal length F, the lens 32 does not collect light emitted from the object 31 and passing through the lens 32 although the lens 32 reduces the divergence angle of the light by its deflecting action. Thus, the lens 32 does not focus an image of the object 31 (i.e. does not form a real image).

Here, the lens 32 forms a virtual image 31v of the object 31 in a position Ov which is in the space where the object 31 is present, and which is farther from the observer than the position O where the object 31 is actually present. If the eye (eye point) 33 of the observer is present in the light path of light emitted from the object 31 and passing through the lens 32, the observer observes the virtual image 31v of the object 31 in the position Ov which is farther than the actual position O of the object 31. In other words, the observer observes the object 31 as a virtual image 31v as if the object 31 is present in the position Ov farther than the actual position O of the object 31.

Note that the observer observes light emitted from an arbitrary point on the object 31 and passing through the lens 32 as if the light is emitted from a point on the virtual image 31v corresponding to the arbitrary point. Thus, the convergence angle of the light emitted from the object 31 and entering the eye 33 of the observer through the lens 32 is smaller than that of the light which is similarly emitted from the object 31 and entering the eye 33 of the observer but in the absence of the lens 32. This makes it possible for the observer, even if presbyopic, to clearly observe the object 31 as the virtual image 31v. Considering now a point A on the object 31 (which is a point remote from the optical axis C of the lens 32), the observer observes light emitted from the point A and passing through the lens 32 as if it is emitted from a corresponding point Av on the virtual image 31v.

More specifically, assume that P is an object observation direction to observe the point A on the object 31 in the absence of the lens 32 (i.e. direction of the point A actually present on the object 31), and Pv is a virtual image observation direction to observe the point Av on the virtual image 31 v formed by the lens 32. Under this assumption, the virtual image observation direction Pv is offset to the periphery of the lens 32 relative to the object observation direction P. Thus, the observer observes the point A on the object 31 (point remote from the optical axis C of the lens 32) as the point Av on the virtual image 31v as if present in the direction offset to the periphery of the lens 32 (i.e. virtual image observation direction Pv) relative to the direction of the point A actually present on the object 31 (i.e. object observation direction P).

The virtual image optical system 4 can be formed by using these relations. More specifically, the virtual image optical system 4 can be formed by assuming the virtual image optical system as the lens 32 in FIG. 3, assuming the position of the display 3 as the point A on the object 31 in FIG. 3, assuming the direction connecting the eye point of the user looking into the viewing opening 2b and the display 3 as the object observation direction P in FIG. 3, and assuming the direction for the user to look into the viewing opening 2b and observe a virtual image on the display 3 (i.e. image capture direction) as the virtual image observation direction Pv in FIG. 3. It is enough that the virtual image optical system 4 comprises at least one lens having light collecting function, but can also comprise lenses, prisms and the like for distortion correction, aberration correction, magnification adjustment and light path deflection. It can also comprise an axial unsymmetrical lens other than an axial symmetrical lens. It can also comprise an optical system having a free-form surface. These technologies are known, for example, from Japanese Laid-open Patent Publications 2004-341027, 2001-242412 and 2001-33690. The virtual image optical system 4 can also be formed to have a prism for deflecting the light path of light from the display 3, and a lens having light collection function for producing a virtual image from the deflected light.

According to the image capture device 1 of the present embodiment, a user can observe an image (while captured) displayed on the display 3 as a real image by directly seeing the display 3 with the display 3 brought to an opened position. The user can also observe the image on the display 3 through the viewing opening 2b of the camera body 2 as a virtual image produced by the virtual image optical system 4 by putting an eye to the camera body 2 and looking into the viewing opening 2b with the display 3 brought to the first opened position (where the image display surface 3a is exposed and positioned to be substantially perpendicular to the image capturing direction by the camera body 2). In other words, the user, if normally sighted, can clearly observe an image, while captured, by directly seeing the display 3. If the user is presbyopic, the user can also clearly observe an image, while captured, through the viewing opening 2b of the camera body 2. The image capture device 1 thus has improved convenience of use.

Furthermore, the image capture device 1 is designed so that the virtual image optical system 4 produces a virtual image of an image displayed on the display 3, so as to allow a user to observe the virtual image through the viewing opening 2b. Thus, it is not necessary to separately provide e.g. an image display element in the camera body 2, thereby preventing an increase in cost. In addition, the virtual image optical system 4 is designed to allow the user to observe the virtual image through the viewing opening 2b (i.e. by putting an eye to the camera body 2), so that the virtual image optical system 4 can be small in size, thereby reducing the size of the image capture device 1. Further, since the virtual image optical system 4 is contained or accommodated in the camera body 2, the image capture device 1 can have an improved design. Besides, the provision of the virtual image optical system 4 inside the camera body 2 makes it possible to prevent the hand of the user from touching the virtual image optical system 4, thereby preventing the virtual image optical system 4 from being stained or damaged, and also preventing degradation in the quality of the image observed through the viewing opening 2b.

In summary, the image capture device 1 of the present embodiment has reduced cost and improved design, and allows a user to clearly observe an image while captured even if the user is presbyopic, and further can prevent degradation in the quality of the observed image. If the user is normally sighted, the user can clearly observe an image, while captured, by looking into the viewing opening 2b of the camera body 2. By looking into the viewing opening 2b of the camera body 2, the user can readily hold the camera body 2 with the arms on the sides of its body and at the same time can observe the image while captured. This makes it possible for the user to prevent hand-shake during image capture.

Besides, when the user directly sees the display 3 with the display 3 brought to the first opened position, the view of the user is not blocked by the virtual image optical system 4, the viewing opening 2b and the virtual image optical system container 2d, thereby allowing the user to easily observe an image while captured, and easily capture an image, improving convenience of use. Furthermore, after the display 3 is brought to the first opened position, the user can both observe the image, while captured, by directly seeing the display 3, and observe the image, while captured, by seeing through the viewing opening 2b, without being required to open or close the display 3, thereby improving convenience of use. In addition, when the user observes an image, while captured, through the viewing opening 2b of the camera body 2, the direction of the line of sight of the user (image observation direction by the user) is parallel to the image capture direction, so that the user can easily capture the image, thereby improving convenience of use.

### Second Embodiment

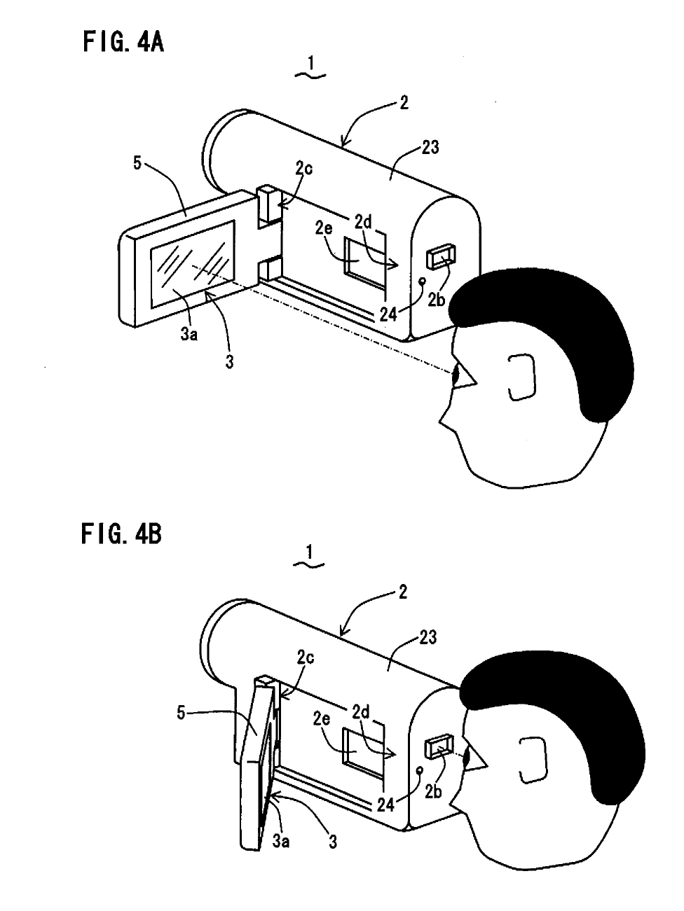

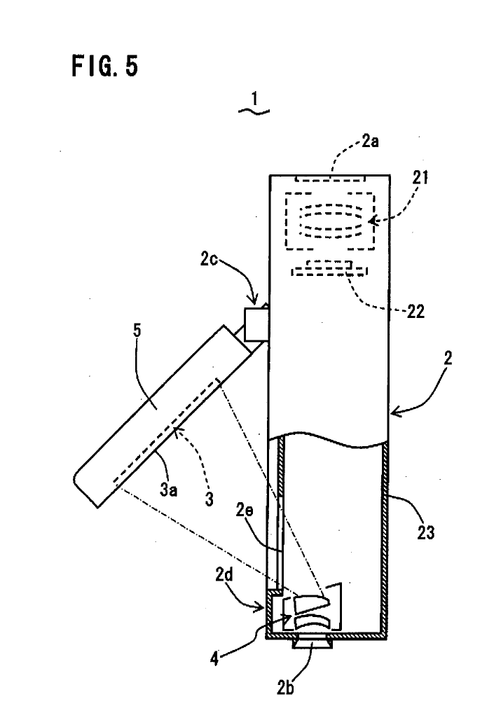

Referring now to FIGS. 4A and 4B and FIG. 5, an image capture device 1 according to a second embodiment of the present invention will be described. FIG. 4A is a schematic perspective view of an image capture device 1 according to the second embodiment when a user directly sees a display 3 which is in a first opened position, while FIG. 4B is a schematic perspective view of the image capture device 1 when the display 3 is in a second opened position, and the user looks into a viewing opening 2b. On the other hand, FIG. 5 is a schematic top plan view, partially in cross section, of the image capture device 1 when the display 3 is in the second opened position. The image capture device 1 of the second embodiment is designed so that by pivoting a lid member 5, a display 3 can be brought to two opened positions where an image display surface 3a is exposed: not only a first opened position (where the image display surface 3a is exposed and substantially perpendicular to the direction for the camera body 2 to capture an image); but also a second opened position (which is a position shown in FIG. 4B and FIG. 5) between the first opened position and a closed position of the display 3 with the image display surface unexposed (not exposed).

In the image capture device 1 according to the present embodiment, a virtual image optical system 4 produces a virtual image of an image displayed on the display 3 when the display 3 is in the second opened position, so as to allow a user to observe the virtual image through a viewing opening 2b. Thus, by putting an eye to the camera body 2 and looking into the viewing opening 2b of the camera body 2 with the display 3 brought to the second opened position, the user can observe an image displayed on the display 3 (i.e. image while captured) through the viewing opening 2b as a virtual image produced by the virtual image optical system 4.

In the image capture device 1 of the present embodiment, a virtual image optical system container 2d does not project from the side surface of the camera body 2, while a light receiving aperture 2e is provided in a side surface of the virtual image optical system container 2d (which is also a side surface of the camera body 2). Similarly as in the first embodiment described above, when the display 3 is in the first opened position, the virtual image optical system 4, the viewing opening 2b and the virtual image optical system container 2d are positioned outside a rectangular space which is formed by indefinitely extending the image display surface 3a in a direction perpendicular thereto such that the virtual image optical system 4, the viewing opening 2b and the virtual image optical system container 2d do not block the view of the user when directly seeing the display 3 brought to the first opened position and observing an image while captured.

Similarly as in the first embodiment, the virtual image optical system 4 produces a virtual image of an image displayed on the display 3 so as to allow the user to observe the virtual image in a direction parallel to the image capture direction by the camera body 2 (i.e. the direction for the camera body 2 to capture the image). Thus, similarly as in the first embodiment, when the user observes the image, while captured, through the viewing opening 2b of the camera body 2, the direction of the line of sight of the user (image observation direction by the user) is parallel to the image capture direction. Further, the virtual image optical system 4 is arranged to be positioned in front of the image display surface 3a when the display 3 is in the second opened position. In other words, the virtual image optical system 4 in the present embodiment produces a virtual image of an image on the display 3 as seen from the front. Thus, the image capture device 1 of the present embodiment with a simple structure can produce a virtual image of an image displayed on the display 3 with e.g. reduced distortion of the virtual image.

In addition to the elements and units in the image capture device 1 of the first embodiment, the image capture device 1 of the present embodiment comprises an LED (light emitting diode) 24 (as shown in FIGS. 4A and 4B) as notifying means for notifying that the image capture device 1 is in a state in which a virtual image of an image displayed on the display 3 (image while captured) can be observed through the viewing opening 2b. More specifically, the LED 24 is designed so that in response to an output of a sensor (not shown) for detecting opened and closed positions of the display 3, the LED 24 is turned on when the display 3 is in the second opened position (thus in a state in which the virtual image of an image on the display 3 can be observed through the viewing opening 2b), while the LED 24 is turned off when the display 3 is in a position other than the second opened position. The LED 24 is provided in the rear surface of the camera body 2 near the viewing opening 2b. Other elements and units in the image capture device 1 of the present embodiment than those described above are the same as those of the first embodiment.

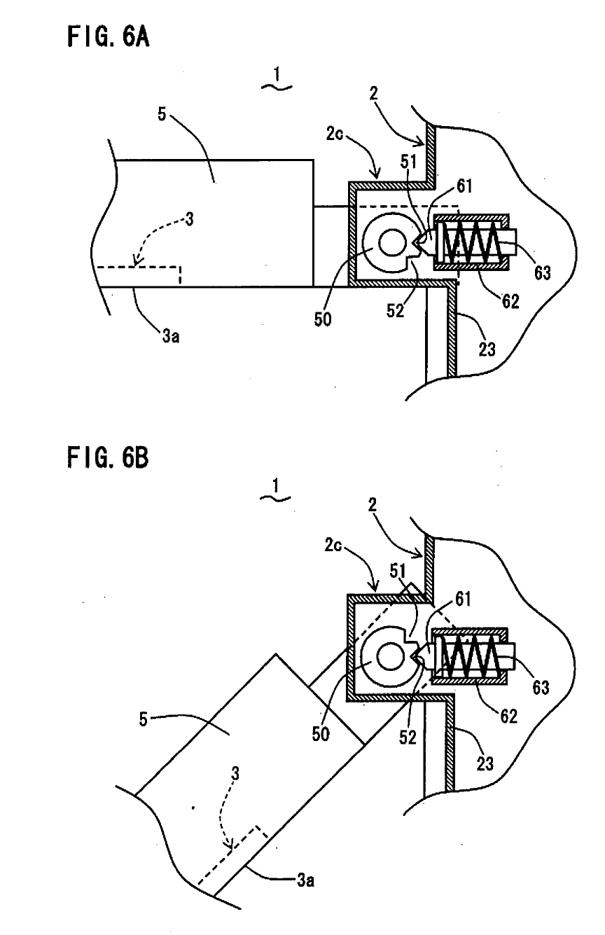

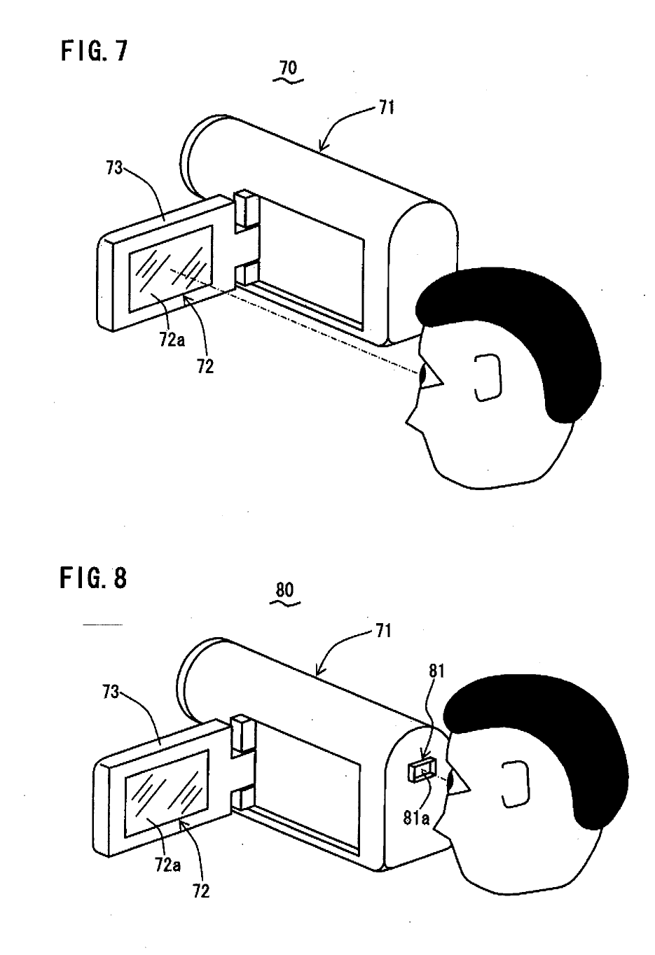

FIG. 6A and FIG. 6B are each a schematic top plan view, partially in cross section, of a portion of the image capture device 1 of the second embodiment, showing a display position holding mechanism to hold the display 3 in the first opened position and the second opened position, respectively. The image capture device 1 comprises a lid member 5 which has the display 3 mounted thereon and has a shaft 50. The shaft 50 of the lid member 5 is rotatably and axially supported in a pivotal support member 2c (in the camera body 2), while the lid member 5 is supported by the camera body 2 so as to pivot around the axis of the shaft 50. Further, the shaft 50 of the lid member 5 has a first recessed portion 51 and a second recessed portion 52.

On the other hand, the camera body 2 has provided therein an engaging member 61, a guide member 62 and a spring 63 for holding the position of the lid member 5 (position of the display 3). The engaging member 61 is slidably supported by the guide member 62, and is biased by the spring 63 to press against the shaft 50 of the lid member 5. When the lid member 5 is pivoted to bring the display 3 to the first opened position, an end of the engaging member 61 engages with the first recessed portion 51 of the shaft 50 (refer to FIG. 6A), whereby the display 3 is held in the first opened position. Further, when the lid member 5 is pivoted to bring the display 3 to the second opened position, the end of the engaging member 61 engages with the second recessed portion 52 of the shaft 50 (refer to FIG. 6B), whereby the display 3 is held in the second opened position.

According to the image capture device 1 of the present embodiment, a user can observe an image displayed on the display 3 as a real image by directly seeing the display 3 with the display 3 brought to an opened position. The user can also observe the image on the display 3 through the viewing opening 2b of the camera body 2 as a virtual image produced by the virtual image optical system 4 by putting an eye to the camera body 2 and looking into the viewing opening 2b with the display 3 brought to the second opened position. In other words, similarly as in the first embodiment, the user, if normally sighted, can clearly observe an image, while captured, by directly seeing the display 3. If the user is presbyopic, the user can also clearly observe an image, while captured, through the viewing opening 2b of the camera body 2. The image capture device 1 thus has improved convenience of use. Thus, similarly as in the first embodiment, the image capture device 1 of the present embodiment has reduced cost and improved design, and allows a user to clearly observe an image while captured even if the user is presbyopic, and further can prevent degradation in the quality of the observed image.

Furthermore, according to the image capture device 1 of the present embodiment, the virtual image optical system 4 produces a virtual image of an image displayed on the display 3 when the display 3 is in the second opened position so as to produce a virtual image when seeing the display 3 from the front. Thus, the image capture device 1 with a simple structure can produce a virtual image of an image displayed on the display 3 with e.g. reduced distortion of the virtual image, making it possible to further reduce cost. In addition, since the virtual image optical system container 2d does not project from the side surface of the camera body 2, it is possible to allow the image capture device 1 to have a further improved design. Besides, by simply checking the on/off state of the LED 24 without actually seeing through the viewing opening 2b, the user can recognize whether the image capture device 1 is in a state in which a virtual image of an image displayed on the display 3, while captured, can be observed through the viewing opening 2b, thereby improving convenience of use.

It is to be noted that the present invention is not limited to the above embodiments, and various modifications are possible within the spirit and scope of the present invention. For example, the image capture device of each embodiment described above can be designed so that the display displays an image thereon while captured even in its closed position, and that the virtual image optical system produces a virtual image of the image on the display so as to allow a user to observe the virtual image when the display is in the closed position. In this case, the virtual image optical system can be designed so as to allow a mirror or a prism to deflect the path of light from the display, and so as to allow a lens having light collecting function to produce a virtual image of an image displayed on the display.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2008-043238 filed Feb. 25, 2008, the content of which is hereby incorporated by reference.

What is claimed is:

1. An image capture device comprising:
a camera body to be held by a user for capturing an image of a target object;
a display with an image display surface for displaying an image while captured by the camera body; and
a virtual image optical system for producing a virtual image of the image displayed on the display,
wherein the display is openably and closably supported by the camera body so as to be positioned in an opened position to expose the image display surface and a closed position to unexpose the image display surface,
wherein the camera body has a viewing opening for a user to observe the image, while captured by the camera body, by putting an eye to the camera body, and
wherein the virtual image optical system is contained in the camera body and produces the virtual image of the image displayed on the display so as to allow the user to observe the virtual image through the viewing opening.

2. The image capture device according to claim 1,
wherein the display can be positioned in a first opened position as the opened position to expose the image display surface where the image display surface is exposed and substantially perpendicular to a direction for the camera body to capture an image, and
wherein when the display is in the first opened position, the virtual image optical system and the viewing opening are positioned outside a rectangular space which is formed by indefinitely extending the image display surface in a direction perpendicular thereto.

3. The image capture device according to claim 2, wherein the virtual image optical system produces the virtual image so as to allow the user to observe the virtual image in a direction parallel to the direction for the camera body to capture the image.

4. The image capture device according to claim 3, wherein the virtual image optical system produces the virtual image so as to allow the user to observe the virtual image through the viewing opening when the display is in the first opened position.

5. The image capture device according to claim 3,
wherein the display can be positioned in a second opened position as the opened position which is between the first opened position and the closed position of the display to unexpose the image display surface,
wherein when the display is in the second opened position, the virtual image optical system produces the virtual image so as to allow the user to observe the virtual image through the viewing opening.

6. The image capture device according to claim 5, which further comprises notifying means for notifying that the image capture device is in a state in which the virtual image can be observed through the viewing opening.

7. The image capture device according to claim 1, which further comprises notifying means for notifying that the image capture device is in a state in which the virtual image can be observed through the viewing opening.

8. The image capture device according to claim 1, wherein the virtual image optical system produces the virtual image so as to allow the user to observe the virtual image in a direction parallel to the direction for the camera body to capture the image.
